(19) United States
(12) Patent Application Publication
(10) Pub. No.: US 2003/0200394 A1
(43) Pub. Date: Oct. 23, 2003

(54) Cache memory arrangement and methods for use in a cache memory system

(75) Inventors: Paul Ashmore, Longmont, CO (US); Michael Huw Francis, Winchester (GB); Simon Walsh, Portsmouth (GB)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/406,127

(22) Filed: Apr. 3, 2003

(30) Foreign Application Priority Data
Apr. 19, 2002 (GB) 0208922.5

(51) Int. Cl. G06F 12/00

(52) U.S. Cl. 711/119; 711/135

(57) ABSTRACT

An arrangement and methods for operation in a cache memory system to facitate re-synchronising non-volatile cache memories (150B, 160B) following interruption in communication. A primary adapter (150) creates a non-volatile record (150C) of each cache update before it is applied to either cache. Each such record is cleared when the primary adapter knows that the cache update has been applied to both adapters' caches. In the event of a reset or other failure, the primary adapter can read the non-volatile list of transfers which were ongoing. For each entry in this list, the primary adapter negotiates with the secondary adapter (160) and transfers only the data which may be different.

The amount of data to be transferred between the adapters following reset/failure is generally much lower than under previous solutions, since the data to be transferred represents only the transactions which were in progress at the time of the reset or failure, rather than the entire non-volatile cache contents; also, new transactions need not be suspended while even this reduced resynchronisation takes place: all that is necessary is for the (relatively short) list of in-doubt quanta of data to be searched (if the transaction does not overlap any entries in this list then it need not be suspended; if it does overlap then the transaction may be queued until the resynchronisation completes).

### FIELD OF THE INVENTION

This invention relates to fault-tolerant computing systems, and particularly to storage networks with write data caching.

### BACKGROUND OF THE INVENTION

In the field of this invention it is known that a storage subsystem may include two (or more) adapters, each with a non-volatile write cache which is used to store data temporarily before it is transferred to a different resource (such as a disk drive).

When a write transaction is received on one adapter (the primary adapter) the associated data is transferred to that adapter and stored in non-volatile memory. This data is also transferred to a second adapter (the secondary adapter) and made non-volatile there too, to provide fault-tolerance. When there is non-volatile data stored in either adapter's cache, the resource is flagged as having data in a cache.

Inherent in this process is a delay between the times when the data is made non-volatile on the two adapters. If a reset or other failure of one or both adapters occurs during this delay, the two non-volatile memory images may differ.

When the adapters subsequently restart operations, the non-volatile memory images must be synchronised (i.e., made to contain the same contents). This is required for a number of reasons:

Either adapter could satisfy a Read transaction from its memory image and these Read transactions must receive consistent data regardless of the receiving adapter.

Data present in one adapter and not the other may consume space on the first adapter indefinitely, thus resulting in a memory leak and reduced non-volatile capacity.

In earlier storage subsystem architecture this problem was solved by:

Invalidating the secondary adapter's cache, Ÿ Flushing the entire primary adapter's cache, and

Marking the resource as having no data in cache.

However, this approach has the disadvantage that all new transactions may be suspended until this flushing operation completes (to avoid the complexity of managing new transactions in parallel with the flushing operation). This can result in new transactions being suspended for many minutes, which is unacceptable in a high-availability fault-tolerant system. Furthermore, customer data is exposed to a single point of failure while this flushing operation is in progress. The secondary adapter's cache must be invalidated before the primary adapter's flush begins, in order to maintain data integrity: if the flush is interrupted (e.g., by a second reset of the primary adapter), the secondary adapter may subsequently flush different data to the resource. Two Read transactions, one before this second reset and one after, would return different data, resulting in a data miscompare.

Alternatively, new transactions may be allowed to proceed in parallel with the flushing operation, extending the time taken for the flushing operation. Using this approach, customer data is still exposed to a single point of failure during this, now slower, flushing operation.

An alternative solution, for example known from U.S. Pat. No. 5,761,705, is to:

Invalidate the secondary cache, and

Copy the entire primary adapter's cache to the secondary adapter's cache.

This would not take as long as the first option, but still a significant time. New transactions would be suspended during this time (unless significant additional complexity is accepted).

A variant of this alternative solution, for example known from U.S. Pat. No. 5,724,501, is (in a first stage) to copy a metadata list and later (in a second stage) to copy the cache data.

A need therefore exists for re-synchronising a remote copy memory image following interruption in communication wherein the abovementioned disadvantage(s) may be alleviated.

### STATEMENT OF INVENTION

In accordance with a first aspect of the present invention there is provided a cache memory arrangement, for use in a data storage system, as claimed in claim 1.

In accordance with a second aspect of the present invention there is provided a method, for operation in a cache memory system, as claimed in claim 4.

In accordance with a third aspect of the present invention there is provided a method, for operation in a cache memory system, as claimed in claim 7.

In a preferred form of the present invention, a primary adapter creates a non-volatile record of each cache update before it is applied to either cache. Each such record is cleared when the primary adapter knows that the cache update has been applied to both adapters' caches.

Consequently, the primary adapter has, at all times, a non-volatile list of all ongoing transfers.

In the event of a reset or other failure, the primary adapter can read the non-volatile list of transfers which were ongoing. For each entry in this list, the primary adapter negotiates with a secondary adapter and transfers only the data which may be different.

### BRIEF DESCRIPTION OF THE DRAWINGS

One method and arrangement for re-synchronising remote copy memory image following interruption in communication incorporating the present invention will now be described, by way of example only, with reference to the accompanying drawing(s), in which:

FIG. 1 shows a block schematic diagram illustrating a data storage system in which the present invention is used;

FIG. 2 shows a flow chart illustrating cache update process in the system of FIG. 1; and

FIG. 3 shows a flow chart illustrating recovery after reset/failure process in the system of FIG. 1.

### DESCRIPTION OF PREFERRED EMBODIMENT

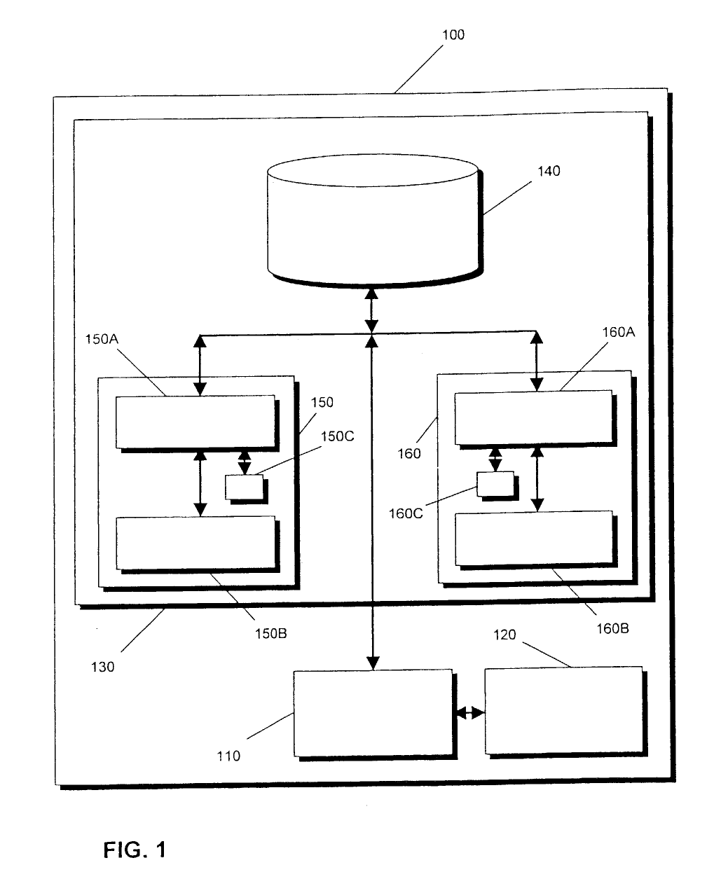

FIG. 1 is a high level block diagram of a data processing system 100, incorporating one or more processors (shown generally as 110), one or more peripheral modules or devices (shown generally as 120) and a disk storage subsystem 130. The disk storage subsystem 130 includes a disk drive arrangement 140 (which may comprise one or more disk arrays of optical and/or magnetic disks), a first cache adapter 150 and a second cache adapter 160. Each of the cache adaptors 150 and 160 has a dynamic memory (150A and 160A respectively) and a non-volatile memory (150B and 160B respectively). Each adapter also includes a further non-volatile memory 150C, 160C respectively.

In use of the system 100, when a write transaction is received on one of the adapters 150 or 160 (the primary adapter) the associated data is transferred to that adapter and stored in non-volatile memory (150B or 160B respectively). This data is also transferred to the other adapter (the secondary adapter) and stored in non-volatile memory (160B or 150B respectively) there too, to provide fault-tolerance. When there is non-volatile data stored in either adapter's cache, the resource is flagged as having data in a cache.

Inherent in this process is a delay between the times when the data is made non-volatile on the two adapters. If a reset or other failure of one or both adapters occurs during this delay, the two non-volatile memory images may differ.

When the adapters subsequently restart operations, the non-volatile memory images must be synchronised (i.e., made to contain the same contents). This is required for a number of reasons:

Either adapter could satisfy a Read transaction from its memory image and these Read transactions must receive consistent data regardless of the receiving adapter.

Data present in one adapter and not the other may consume space on the first adapter indefinitely, thus resulting in a memory leak and reduced non-volatile capacity.

In order to satisfy this synchronization requirement, the system 100 employs the following scheme.

As will be explained in greater detail below, the primary adapter (150 or 160) creates a non-volatile record (in non-volatile memory 150C or 160C respectively) of each cache update before it is applied to either cache's non-volatile memory 150B or 160B respectively. Each such record is cleared when the primary adapter knows that the cache update has been applied to both adapters' non-volatile memories.

Consequently, the primary adapter has, at all times, a non-volatile list (in non-volatile memory 150C or 160C respectively) of all ongoing transfers.

In the event of a reset or other failure, the primary adapter reads the non-volatile list of transfers which were ongoing. For each entry in this list, the primary adapter negotiates with the secondary adapter and transfers only the data which may be different.

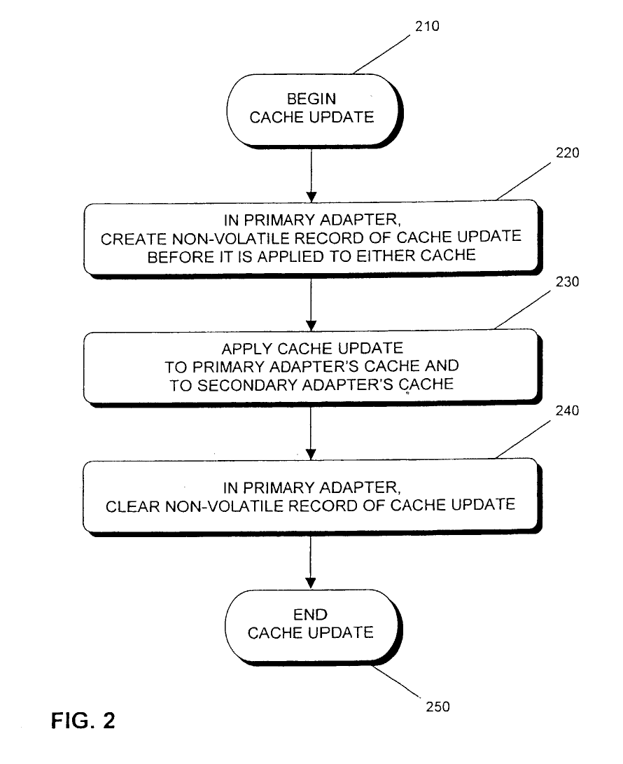

Referring now to FIG. 2, the method for cache update employed in the system 100 begins at step 210. Then, at step 220, in the primary adapter, a non-volatile record (in non-volatile memory 150C or 160C) of the cache update is created before it is applied to either cache's non-volatile memory 150B or 160B. Then, at step 230, the cache update is applied to the primary adapter's non-volatile memory and to the secondary adapter's non-volatile memory 150B and 160B. Then, at step 230, in the primary adapter the non-volatile record (in memory 150C or 160C) of the cache update is cleared. The cache update ends at step 250.

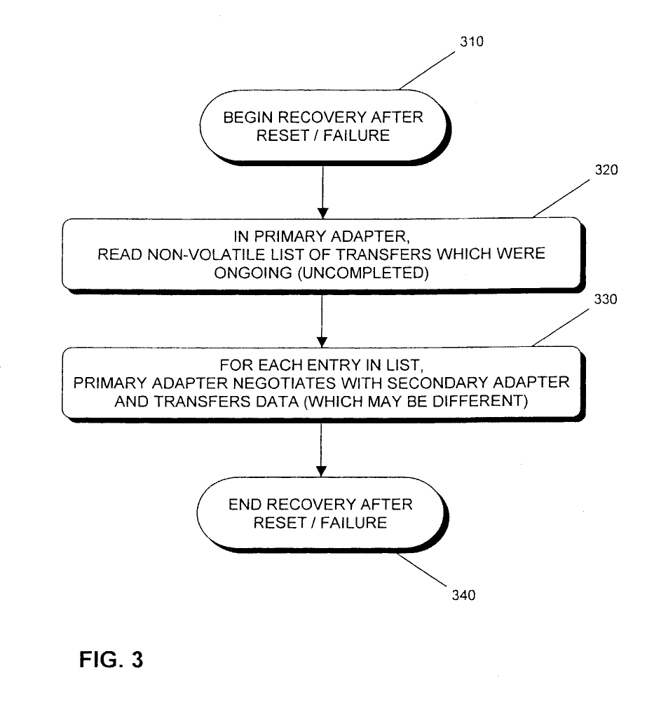

Referring now to FIG. 3, the method for recovery after reset/failure employed in the system 100 begins at step 310. Then, at step 320, in the primary adapter, the list (in the non-volatile memory) of transfers which were ongoing (uncompleted) at reset/failure is read. Then, at step 330, for each entry in list, the primary adapter negotiates with the secondary adapter and transfers to the secondary adapter data (which may be different between the primary and secondary adapters). The recovery after reset/failure ends at step 340.

It will be understood that the arrangement and method for re-synchronising remote copy memory image following interruption in communication described above provides the following advantages:

The amount of data to be transferred between the adapters following reset or failure will be, in general, significantly lower than under previous solutions, since the data to be transferred represents only the transactions which were in progress at the time of the reset or failure, rather than the entire non-volatile cache contents; and

New transactions need not be suspended while even this reduced resynchronisation takes place: all that is necessary is for the (relatively short) list of in-doubt quanta of data to be searched. If the transaction does not overlap any entries in this list then it need not be suspended; if it does overlap then the transaction may be queued until the resynchronisation completes.

It will be appreciated that the methods described above for cache update and for recovery after reset/failure in a data processing system may be carried out in software running on a processor (not shown), and that the software may be provided as a computer program element carried on any suitable data carrier (also not shown) such as a magnetic or optical computer disc.

It will be appreciated that various modifications may be made to the embodiments described above. For example, the non-volatile ‘list’ memory (150C, 160C) described above as separate from the ‘main’ non-volatile memory (150B, 160B) in each adapter may in practice be provided within the non-volatile memory 150B or 160B of each adapter. Further modifications will be apparent to a person of ordinary skill in the art.

What is claimed is:

1. A cache memory arrangement for use in a data storage system, the arrangement comprising:
first cache means having non-volatile memory means for storing a first copy of data; and
second cache means having non-volatile memory means for storing a second copy of said data, and additional non-volatile memory means associated with at least one of the first cache means and the second cache means, the additional non-volatile memory means being arranged to hold a list of ongoing cache data storage transactions for which data storage in the non-volatile memory means of both the first and second cache means have not been completed, the list being arranged to be cleared of cache data storage transactions for which data storage in the non-volatile memory means of both the first and second cache means have been completed.

2. The arrangement of claim 1 wherein the first and second cache means further have volatile memory means.

3. A disk storage system comprising the arrangement of claim 1.

4. A method for operation in a cache memory system including first cache means having non-volatile memory means for storing a first copy of data; and second cache means having non-volatile memory means for storing a second copy of said data, the method comprising:
providing additional non-volatile memory means associated with at least one of the first cache means and the second cache means,
storing in the additional non-volatile memory means a list of ongoing cache data storage transactions for which data storage in the non-volatile memory means of both the first and second cache means have not been completed, and
removing from the list cache data storage transactions for which data storage in the non-volatile memory means of both the first and second cache means have been completed.

5. The method of claim 4 wherein the first and second cache means further have volatile memory means.

6. The method of claim 4 wherein the cache memory system is arranged to operate in a disk storage system.

7. A method for operation in a cache memory system including first cache means having non-volatile memory means for storing a first copy of data, second cache means having non-volatile memory means for storing a second copy of said data, and additional non-volatile memory means associated with at least one of the first cache means and the second cache means for storing a list of ongoing cache data storage transactions for which data storage in the non-volatile memory means of both the first and second cache means have not been completed, the method comprising:
re-synchronising the first and second cache means by:
reading from the list stored in the additional non-volatile memory means; and
for each transaction in the list, transferring data from the non-volatile memory means of one of the first and second cache means to the non-volatile memory means of the other of the first and second cache means.

8. The method of claim 7 wherein the first and second cache means further have volatile memory means.

9. The method of claim 7 wherein the cache memory system is arranged to operate in a disk storage system.

10. A computer program element comprising computer program means for performing the method of claim 4.

11. A computer program element comprising computer program means for performing the method of claim 9.
